(19) United States
(12) Patent Application Publication
(10) Pub. No.: US 2005/0217904 A1
(43) Pub. Date: Oct. 6, 2005

(54) Container with built-in weighing device

(76) Inventor: Michael L. Hughes, Boca Raton, FL (US)

Correspondence Address: MICHAEL L. HUGHES, 17076-4 BOCA CLUB BOULEVARD, BOCA RATON, FL, 33487, US

(21) Appl. No.: 10/816,872

(22) Filed: Apr. 5, 2004

(51) Int. Cl. B62B 1/00; B62B 7/02; G01G 19/00; G01G 23/00

(52) U.S. Cl. 177/245

(57) ABSTRACT

The invention is a new and improved container, such as luggage, or a shipping crate with a built-in device for displaying the weight of said container. The invention herein is used to provide a convenient means for a user to determine the total weight of a container; one purpose being to comply with airline luggage weight restrictions imposed by airline companies, as well as other uses. The said invention is particularly useful in airports but could be used with other cargo transport systems as well.

### BACKGROUND OF THE INVENTION

1. Field of the Invention

The present invention relates generally to personal and commercial shipping and more specifically relates to containers used for transporting contents, such as luggage, having a built-in weighing device. This invention would be particularly useful in an airport and can also be used in other places, including other cargo transport systems.

2. Description of the Related Art

Almost all airline passengers bring at least one, and many times two bags of luggage onboard of an airplane. These luggage, which are turned over to the airline at the airport ticketing counter or at the airport curbside check-in counter, are many times are packed so tightly, that their weight becomes an issue with the airline. In recent years, airline companies have imposed weight restrictions on passengers' checked luggage. For example, at the present time Delta Airlines, one on the nation's largest airline companies, has a weight restriction of 50 lbs. per checked luggage. Any luggage up to 20 lbs. over that amount (51 lbs.-70 lbs.) is subject to a $25 overweight fee. In the event a checked luggage is over 70 lbs, the Delta passenger is required to pay a $80 overweight fee to check their luggage on their flight.

There are a variety of known containers and weighing devices in the prior art. Of background interest is U.S. Pat. No. 5,414,225 Garfinkle “Mobility-disabled portable weighing device” issued 9 May 1995 which describes and illustrates a portable device intended to be placed under the wheels of a wheelchair to weigh the wheelchair and disabled person sitting in the chair. The device however, must be placed under one set of wheels, then placed under the other set of wheels to acquire two measurements that are used to determine the actual weight. Additionally, the device does not address the field of personal and commercial shipping, and is not designed to be a part of, or attached to the item that it is weighing.

Also of background interest is United Kingdom Patent No. GB 2385142A, titled “Luggage Weighing Gadget” issued 13 Aug. 2003 and United Kingdom Patent No. GB0203208A titled “Handy Luggage Weighing Gadget” issued 27 Mar. 2002, and United Kingdom Patent No. GB0007620A “Handy Luggage Weighing Gadget” issued 17 May, 2000; all by Amal Ghosh, which all are aspects of a handheld luggage weighing gadget and uses an electronic, mechanical or strain gauge weight sensing system, and displays the weight of the luggage as LED as the handheld device is slipped under the handle of the luggage and pulled. This device is not designed to be a part of, or attached to the item that it is weighing. In addition, this invention is designed to determine a luggage's weight by picking up the luggage by it's handle and suspending it off the ground for enough time to read the measuring device, which is not practical for a heavy container or piece of luggage.

French Patent FR 2,581,602 Gendreau “Self-Weighing Trailer for Cereal and Fodder” 14 Nov. 1986 was another patent of background interest found. This is an electronic weighing device that is used on a large trailer. This invention addresses the weight of a trailer or vehicle, and is not practical for the use of weighing a piece of luggage or package intended to be carried and shipped.

Similarly, there is British patent GB 576,954 Welch “Self-Weighing Wheelbarrow” 29 Apr. 1926, which is a wheelbarrow with a mechanical scale built into the device. As with the prior finding, this invention also addresses the weight of a different object, and is not practical for the use of weighing a piece of luggage or package intended to be carried and shipped, and further, does not address the field of personal and commercial shipping.

An International patent of relevance is PCT 9831250 Tan “Self-Weighing School Bag” 23 Jul. 1998. This is a mechanical scale built into a backpack to measure its weight. This has similar aspects of the present invention, however, it uses a mechanical means to measure weight. This is not as accurate, compact, or as lightweight as the electronic means of the present invention. Also, it is always active as one is carrying the bag unlike the present invention which is activated upon an “as needed” basis. In addition, this invention is designed to determine a school bag's weight by picking up the bag and suspending it off the ground for enough time to read the measuring device. While this may be appropriate for a school bag, it is not practical for a heavy container or piece of luggage.

A published US patent application of background relevance is U.S. Application No. 20020162716 by Fabritz. This relates to luggage that doubles as a backpack. Although it's aspects are novel, it does not contain any form of weighing device, and does not address the issue of luggage weight awareness.

Although there are luggage devices in the prior art with similar aspects of said invention, there are currently no container or luggage devices in the prior art that specifically and effectively address the issue of luggage weight awareness.

Generally, passengers do not know the exact weight of their luggage until they go to the airline check-in counter and have their luggage weighed on a scale. On many occasions, the unsuspecting passenger has packed their luggage so tightly, that it exceeds the airline's luggage weight restrictions. This, unfortunately leaves the unsuspecting and unprepared passenger at the airline check-in counter with three options;
1. Pay the overweight fee to the airline company, which can be a costly expense.
2. Possibly purchase a secondary “temporary” luggage, usually made of cardboard, from the airline company for $10 to $30 for the excess weight, which is also a costly expense.
3. Suffer the embarrassment of opening one's luggage at the airport counter to determine which items in the luggage are the heaviest, and carry them onboard on one's person.

One disadvantage to this system is the unexpected expense to the passenger, which in most cases could have easily been avoided if the said passenger was aware of the weight of their luggage before arriving to the airport.

Another disadvantage to this system is the embarrassment of opening one's luggage in front of strangers at the airline check-in counter to remove chosen items, knowing that their lack of preparation is causing the other passengers behind them a further delay.

There are other situations where weight of a container would be important to know. One such place would be in the area of mailing cargo or bulk objects. In many cases there are maximum weight restrictions enforced by cargo transport companies that are unintentionally exceeded by customers. The owner of a heavy package will not know of this until the container has been packed and is at the shipping company (for example FedEx, USP or DHL). The customer must then unpack the container and repackage it with fewer items. This similar situation may arize shipping via air freight, or trucking freight where there is a weight limit on what may be transported.

Currently, there is a need to quickly and effectively provide information regarding the physical properties of a container, such as the weight of a container.

### SUMMARY OF THE INVENTION

In view of the foregoing disadvantages inherent in the known types of containers now present in the prior art, the present invention provides a new, improved container with built-in weighing device.

In these respects, a container with built-in weighing device, substantially departs itself from the conventional concepts and designs of the prior art, and in so doing provides an apparatus developed for the purpose of effectively and immediately notifying said users of the weight of the container and its contents.

This weighing device may be a scale built into the container or weighing device, that is attached or retrofitted to the container. One embodiment of the invention is a piece of luggage having the standard features available on conventional luggage in the prior art with a built-in weighing device used for the purpose of determining the weight of the said luggage.

One advantage of the said invention is the passengers' benefit of luggage weight awareness; allowing an unsuspecting airline passenger to make any necessary weight adjustments needed to comply with airline luggage weight restrictions before they get to the airline check-in counter, thereby avoiding any additional fees, delays and embarrassment.

There has thus been outlined, rather broadly, the more important features of the invention in order that the detailed description thereof may be better understood, and in order that the present contribution to the art may be better appreciated. There are additional features of the invention that will be described hereinafter.

In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. In addition, the improved container as taught herein can be shaped into different appearances including different sizes and shapes. This invention applies to other types of containers which carry contents where the weight is of interest. These typically are used for shipping purposes. Also, it is to be understood that the phraseology and terminology employed herein are for the purpose of the description and should not be regarded as limiting.

To the accomplishment of the above and related objects, this invention may be embodied in the form illustrated in the accompanying drawings, attention being called to the fact, however, that the drawings are illustrative only, and that changes may be made in the specific construction illustrated.

### OBJECTS OF THE INVENTION

A primary object of the present invention is to provide a self-weighing device in a container such as luggage or a cargo container.

Another objective of the present invention is to provide a convenient means for a user to determine the weight of their luggage, for the purpose of complying with airline luggage weight restrictions imposed by airline companies.

A further objective of the present invention is to provide a luggage that will overcome the shortcomings of the prior art devices as described above.

Other objects and advantages of the present invention will become obvious to the reader and it is intended that these objects and advantages are within the scope of the present invention.

### BRIEF DECRIPTION OF THE DRAWING

Various other objects, features and attendant advantages of the present invention will become fully appreciated as the same becomes better understood when considered in conjunction with the accompanying drawings, in which like reference characters designate the same or similar parts throughout the several views, and wherein:

FIG. 1 is a perspective view, depicting a one embodiment of a luggage device according to the present invention in a horizontal position;

FIG. 2 is a perspective view, depicting the luggage device shown in FIG. 1 in an upright position with the handle assembly in a projected position;

FIG. 3 is a cutaway view, depicting a close up view of the base of the luggage device of the present invention in an upside down position;

FIG. 4 is a perspective view, depicting the luggage device of FIG. 2 in a tilted position for pulling or pushing on wheels;

FIG. 5 is a cutaway view depicting a close up view of the top of the luggage device shown in FIG. 3;

FIG. 6 is a perspective view of a shipping container showing an integral weighing device.

### DETAILED DESCRIPTION OF THE INVENTION

Turning now descriptively to the drawings, in which similar reference characters denote similar elements throughout several views, the attached figures illustrate a luggage with built-in weighing device.

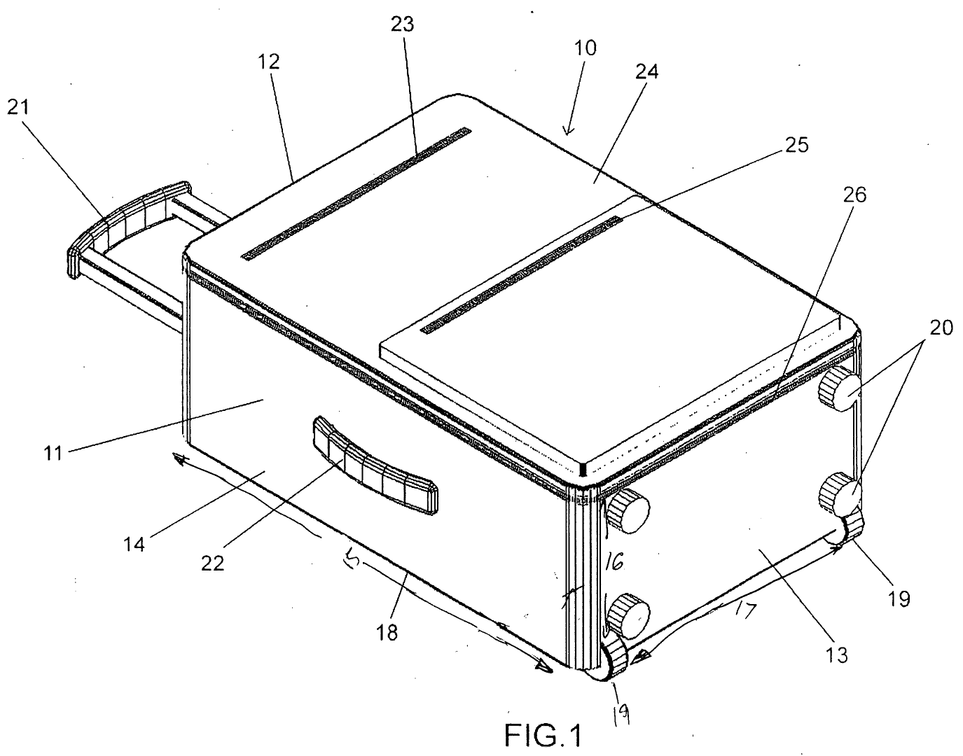

FIG. 1, One embodiment of a luggage device (10) of the present invention is shown which includes a body or container portion (11) having a top (12), a bottom (13) and a plurality of sidewalls (14). Although the luggage device is shown as having a generally rectangular box configuration, various other shapes are possible. In the embodiment shown in the figures, the luggage device (10) has a long dimension (15) and two shorter dimensions (16), (17) to thereby define the rectangular box shape. As such, the luggage device (10) has a horizontal or low profile when positioned on it's back (18) to fill so that the long dimension (15) is touching or parallel to the ground.

The device (10) further includes a retractable handle assembly (21), which is used in transporting the luggage device (10). When tilted onto the pair of wheels (19), the device (10) can be pushed of pulled as desired by applying a force to the handle assembly (21). The device can further be equipped with a handle assembly (22) attached to the top (12) or to another of the sidewalls (14). The handle assembly (22) allows a traveler to carry the luggage device (10) when convenient.

The luggage device (10) additionally includes a plurality of zippers providing access to various compartments of the luggage device (10). A first zipper (23) is configured in the top of the lid (24) of the luggage device (10) and provides access to a pocket or storage compartment in the top of the lid (24). A second zipper (25) is configured in the bottom of the lid (24) of the luggage device (10) and provides access to a pocket or storage compartment in the bottom of the lid (24). A third zipper (26) provides access to an interior compartment of the body or main portion (11) of the luggage device (10). The interior compartment can be used for transporting items.

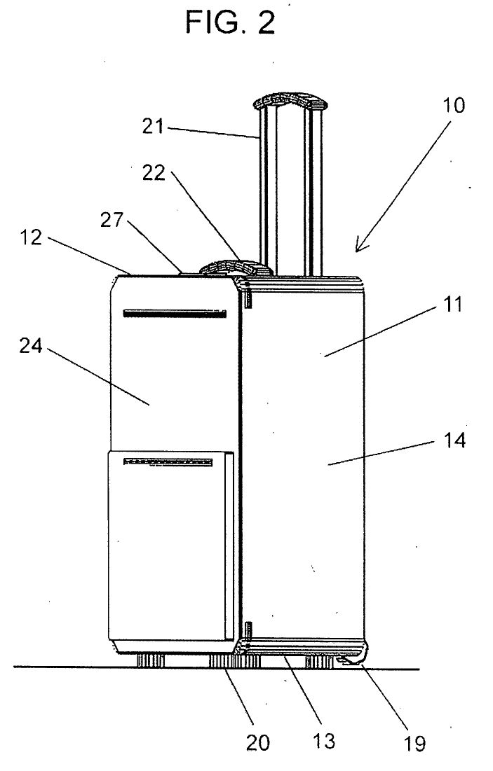

FIG. 2, The luggage device (10) includes a pair of wheels (19) which are attached from the bottom (13) of the luggage device (10). The luggage device (10) further includes a plurality of weight sensors (20), which are attached to the bottom (13) of the luggage device (10), and act as legs when the luggage device (10) is standing upright.

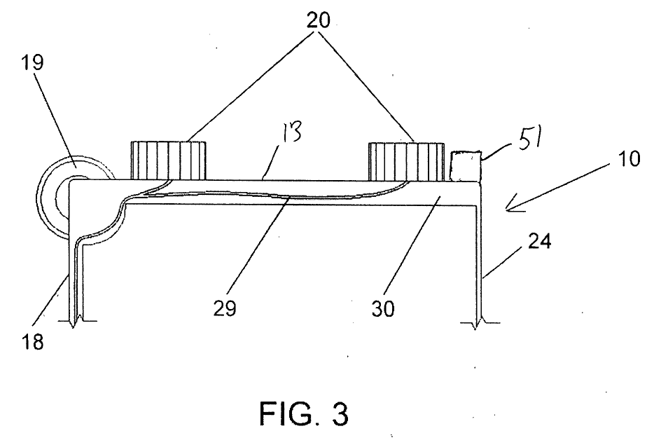

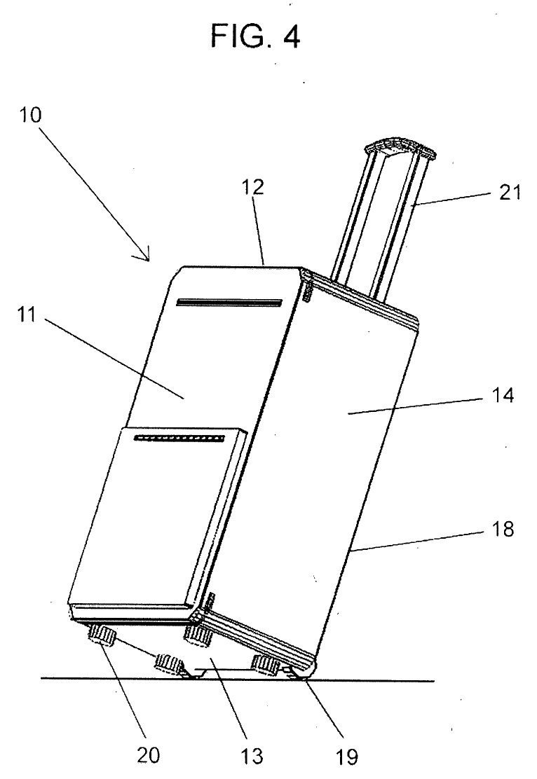

FIG. 3. It is contemplated that in a preferred embodiment, the weight sensors (20) be spaced sufficiently to provide the luggage device (10) with ample balance and support, thus making the device highly stable. It is further contemplated that in a preferred embodiment, the pair of wheels (19) which are attached to the bottom (13) of the luggage device (10) are strategically fastened in a retracted position, thereby only touching the ground when the luggage device (10) is tilted on it's back (18) as seen in FIG. 4.

FIG. 3, In an alternative embodiment the luggage device (10) has at least one additional support, such as support (51). Sensors (20) are designed to be adjustable and they may be retracted to protrude less then the wheels (19) and support (51). In this retracted position, the weight of luggage device (10) rests on the wheels (19) and support (51).

Sensors (20) may then be placed in the extended position, protruding more than wheels (19) and support (51), thereby causing the weight of luggage device to press upon sensors (20) when the luggage device (10) is in the upright position.

The adjustable nature of sensors (20) allows them to be moved from the active (extended) position to an inactive (protected).

Any method of retracting the sensors (20) commonly known at the present time would be effective here as, for example, a screw type mechanism. Sensors (20) are mounted on a base in which sensors (20) are allowed to be screwed into the base into a retracted position. The sensors (20) may also be screwed outwardly to protrude and be placed in an active position, capable of weighing the luggage device (10).

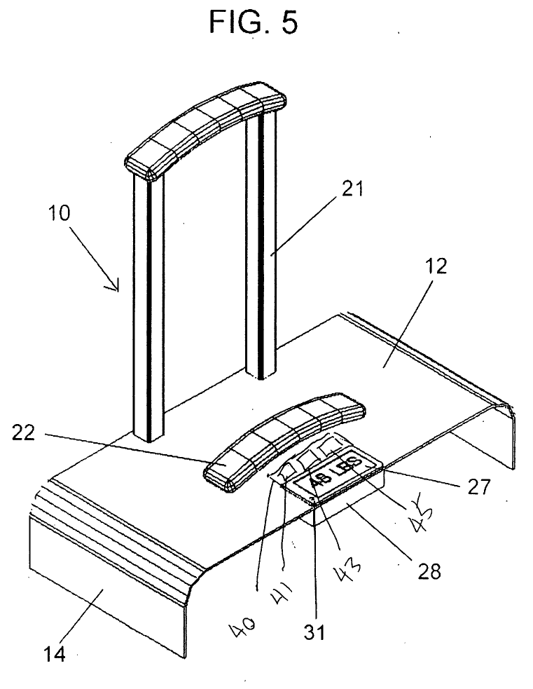

FIG. 5. In a preferred embodiment, the top (12) of the luggage device (10) is equipped with a LCD, or similar display screen (27), under which is a housing structure (28), containing electronic circuitry within the housing, and a power source to provide electrical power to the circuitry of the display screen (27), which can be accessed from the interior compartment of the body of the luggage device (10).

The present invention may employ commonly known circuitry capable of measuring sensor data from the weight sensors (20), and converting the data into actual weight, which is then displayed on display screen (27). Said display screen (27) retrieves and displays the weight and other data from the electronic circuitry.

A panel (40) may be employed having a switch (41) which may be used which, when pressed, will toggle the readout between pounds, kilograms, or other equivalent weight measurement units. This will aid in international travel or shipping.

Another switch (43) may be employed to activate a light on display screen (27), [Another button (45) may] or automatically calculate the net contents of the luggage device (10) [or container] by having subtracted the pre-stored weight of the empty luggage device (10) or container from the total measured weight.

The power, source may be a battery, capacitor that may be charged from an outside source, or an inductively coupled device which receives energy from an outside applied magnetic or electric field. The display screen (27) is connected directly or indirectly, to the weight sensors (20) located on the base (13) of the luggage device (10) as seen in FIG. 3, through a [multi-conductor] cable (29) or other means to transfer weight data to the display screen, and is fastened within the lining (30) of the luggage device (10), and therefore is not visible to the traveler. The circuitry is structured to turn on and read an immediate, instant or current weight or value when the luggage device (10) placed upright on the weight sensors (20) or when activated by a switch (45) and to communicate said signals to the associated display screen (27) located on the top (12) of the luggage device (10). After a period of time, the display screen (27) will resume to the off position for the purpose of power conservation, however can be reactivated by the traveler placing the luggage device (10) upright on the weight sensors (20) located on the base (13) of the luggage device (10) as seen in FIG. 2, or when re-activated by a switch (45) located on the panel (40) of the luggage device (10).

In at least one embodiment of the present invention, the circuitry is designed to turn itself off after a short period of time to conserve power. In a preferred embodiment shown in FIG. 5, the electronic circuitry within the housing structure (28) will be a switch, recessed button, or similar means (31), which allows the user to turn on or turn off the weighing mechanism of the said luggage device (10) if so desired. The said switch (31) may also be used to reactivate the circuit, and display the weight on the display screen (27).

In an alternative embodiment, the said weight sensor(s) (20) of the luggage device (10) are located in the interior compartment of the body (11) of the said luggage device (10), and can determine the gross weight of the luggage device (10) and contents by adding the net weight of said contents to the net weight of the luggage device (10) pre-stored in the electronic circuitry within the housing structure (28).

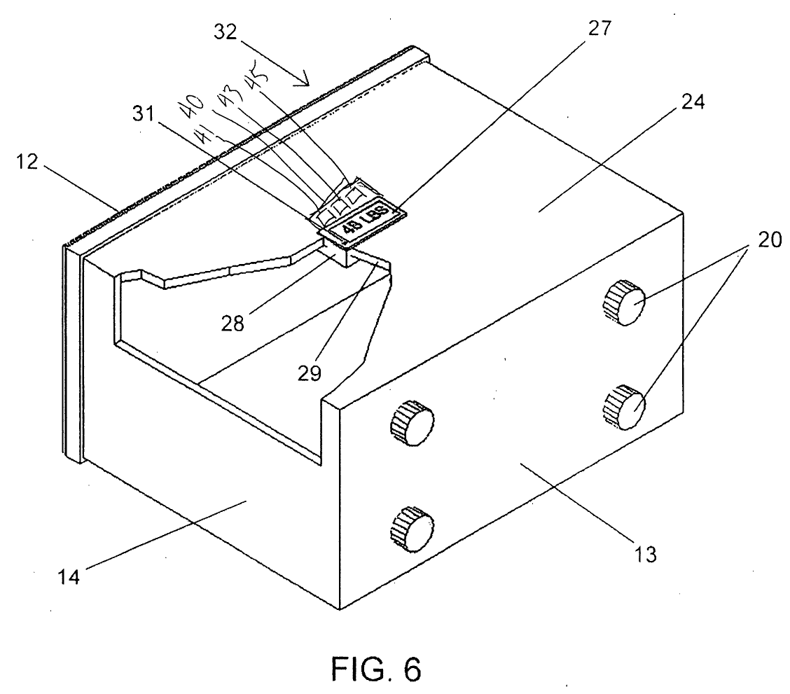

FIG. 6, shows an embodiment similar to those of FIG. 1 where the container is a shipping container which may be either reusable, or disposable, as opposed to a piece of luggage that employs an integral weighing device. The container (24) employs a display screen (27) connected to the electronic circuitry (28). Weight sensors (20) function as described above and provide their information to the electronic circuitry (28) to be displayed on the display screen (27).

As to a further discussion of the manner of usage and operation of the present invention, the same should be apparent from the above description. Accordingly, no further discussion relating to the manner of usage and operation will be provided.

With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

Should any provision of this patent be void or unenforceable for any reason, such provision shall be deemed omitted and this patent with such provision omitted shall remain in full force and effect.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. (canceled)

33. A device comprising:
a luggage capable of holding and transporting contents having at least one built-in electronic, self-weighing device.

34. The electronic, self-weighing luggage device of claim 33 comprising:
a) at least one weight sensor for creating a data signal which includes a current weight of the luggage with contents;
b) a display mechanism capable of displaying an indication of the current weight to a user; and
c) system electronics for receiving the data signal from at least one weight sensor that converts the data signal into an indication of weight and for displays the indication of weight on the display mechanism when activated.

35. The device of claim 33, wherein the weighing device includes at least one weight sensor which is capable of determining the weight of the luggage.

36. The device of claim 33 wherein the luggage device is a shipping container.

37. The device of claim 33 wherein the weighing device can be activated by a user.

38. The device of claim 33 in which the luggage is comprised of a main body having a long side and at least one short side; a pair of wheels, a retractable handle assembly, and a plurality of zippers providing access to various compartments of the luggage.

39. The device of claim 38 in which the wheels are strategically fastened in a retracted position to not interfere with at least one weight sensor of the luggage.

40. The device of claim 38 in which the wheels are strategically fastened in a retracted position to only touch the ground when the luggage device is tilted on its side.

41. The device of claim 34, wherein at least one weight sensor is located about a selected one of a base, feet, sides, handle, interior compartment or top of the luggage.

42. The device of claim 34 wherein the system electronics are connected to a power source, which can provide electrical power to the electronic circuitry.

43. The device of claim 42, wherein the power source comprising: at least one battery, power capacitor and inductively coupled power source.

44. The device of claim 34 wherein the display mechanism automatically turns off after a period of time.

45. The device of claim 34 wherein the display mechanism can be turned on or off manually by a user.

46. The device of claim 34 wherein the display mechanism contains a light which can be activated by a user.

47. The device of claim 34 wherein the system electronics can convert the readout value on the display mechanism between pounds, kilograms, and other values.

48. The device of claim 34 wherein at least one weight sensor is retractable such that it can be active when not retracted and can be inactive when retracted.

49. The device of claim 34 wherein the display indicator is an audio output device located about the luggage device.

50. The method of measuring and indicating a weight of luggage and contents with a self-contained, electronic weighing device comprising:
creating a signal from at least one weight sensor;
receiving the signal from the at least one weight sensor by system electronics;
converting the signal by the system electronics into an equivalent indication of weight; and
displaying the indication of weight on a display.

51. The method according to claim 50 wherein the weighing device can be activated by a user and the weight will show on the display.

52. A method according to claim 50 wherein at least one weight sensor is used to synthesize and transmit data.

53. A method according to claim 50 wherein the data is outputted from at least one weight sensor to system electronics located about the luggage device.

54. A method according to claim 50 wherein the display is activated by a user and automatically turns off after a period of time.

55. A method according to claim 50 wherein the system electronics can convert the signal between pounds and kilograms and output the values to the display.

56. The method of claim 50 wherein the at least one weight sensor is retractable such that it can be active when not retracted and can be inactive when retracted.

57. A method according to claim 50 wherein the display receives and displays multiple kinds of data from the system electronics.

58. A method according to claim 50 wherein the electronic weighing device indicates the luggage's weight to a user through audio means.
